(19) United States
(12) Patent Application Publication
(10) Pub. No.: US 2011/0173004 A1
(43) Pub. Date: Jul. 14, 2011

(54) Device and Method for Noise Shaping in a Multilayer Embedded Codec Interoperable with the ITU-T G.711 Standard

(76) Inventors: Bruno Bessette, Sherbrooke (CA); Jimmy Lapierre, Orford (CA); Vladimir Malenovsky, Sherbrooke (CA); Roch Lefebvre, Canton de Magog (CA); Redwan Salami, St-Laurent (CA)

(21) Appl. No.: 12/664,010

(22) PCT Filed: Dec. 28, 2007
(86) PCT No.: PCT/CA2007/002373

§ 371 Date: Jun. 11, 2010

Related U.S. Application Data
(60) Provisional application No. 60/929,124, filed on Jun. 14, 2007.
(60) Provisional application No. 60/960,057, filed on Sep. 13, 2007.

(51) Int. Cl. G10L 19/00

(52) U.S. Cl. 704/500; 704/E19.001

(57) ABSTRACT

A device and method for shaping noise during encoding of an input sound signal comprise pre-emphasizing the input signal or a decoded signal from a given sound signal codec to produce a pre-emphasized signal, computing a filter transfer function based on the pre-emphasized signal, and shaping the noise by filtering the noise through the transfer function to produce a shaped noise signal, wherein the noise shaping comprises producing a noise feedback. A device and method for noise shaping in a multilayer codec, including at least Layer 1 and 2, comprise: at an encoder, producing an encoded sound signal in Layer 1 including Layer 1 noise shaping, and producing a Layer 2 enhancement signal; at a decoder, decoding the Layer 1 encoded sound signal to produce a synthesis signal, decoding the enhancement signal, computing a filter transfer function based on the synthesis signal, filtering the enhancement signal through the transfer function to produce a Layer 2 filtered enhancement signal, and adding the filtered enhancement signal to the synthesis signal to produce an output signal including contributions from Layer 1 and 2.

### FIELD OF THE INVENTION

The present invention relates to the field of encoding and decoding sound signals, in particular but not exclusively in a multilayer embedded codec interoperable with the ITU-T (International Telecommunication Union) Recommendation G.711. More specifically, the present invention relates to a device and method for noise shaping in the encoder and/or decoder of a sound signal codec.

For example, the device and method according to the present invention are applicable in the narrowband part (usually the first, or lower, layers) of a multilayer embedded codec operating at a sampling frequency of 8 kHz. Unlike ITU-T Recommendation G.711, which has been optimized for signals in the telephony bandwidth, i.e. 200-3400 Hz, the device and method of the invention significantly improve quality for signals whose range is 50-4000 Hz. Such signals are ordinarily generated, for example, by down-sampling a wideband signal whose bandwidth is 50-7000 Hz or even wider. Without the device and method of the invention, the quality of these signals would be much worse and with audible artefacts when encoded and synthesized by the legacy G.711 codec.

### BACKGROUND OF THE INVENTION

The demand for efficient digital wideband speech/audio encoding techniques with a good subjective quality/bit rate trade-off is increasing for numerous applications such as audio/video teleconferencing, multimedia, wireless applications and IP (Internet Protocol) telephony. Until recently the speech coding systems were able to process only signals in the telephony frequency bandwidth, i.e. 200-3400 Hz. Today, an increasing demand is seen for wideband systems that are able to process signals in the frequency bandwidth 50-7000 Hz. These systems offer significantly higher quality than the narrowband systems since they increase the intelligibility and naturalness of the sound. The frequency bandwidth 50-7000 Hz was found sufficient to deliver a face-to-face quality of speech during conversation. For audio signals such as music, this frequency bandwidth provides an acceptable audio quality but still lower than that of CD which operates in the frequency bandwidth 20-20000 Hz.

ITU-T Recommendation G.711 [1] at 64 kbps and G.729 at 8 kbps are two codecs widely used in packet-switched telephony applications. Thus, in the transition from narrowband to wideband telephony there is an interest to develop wideband codecs backward interoperable to these two standards. To this effect, the ITU-T has approved in 2006 Recommendation G.729.1 which is an embedded multi-rate coder with a core interoperable with ITU-T Recommendation G.729 at 8 kbps. Similarly, a new activity has been launched in March 2007 for an embedded wideband codec based on a narrowband core interoperable with ITU-T Recommendation G.711 (both μ-law and A-law) at 64 kbps. This new G.711-based standard is known as the ITU-T G.711 wideband extension (G.711 WBE).

In G.711 WBE, the input sound signal, sampled at 16 kHz, is split into two bands using a QMF (Quadrature Mirror Filter) filter: a lower band from 0 to 4000 Hz and an upper band from 4000 to 7000 Hz. If the bandwidth of the input signal is 50-8000 Hz the lower and upper bands are 50-4000 Hz and 4000-8000 Hz, respectively. In the G.711 WBE, the input wideband signal is encoded in three (3) Layers. The first Layer (Layer 1; the core) encodes the lower band of the signal in a G.711-compatible format at 64 kbps. Then, the second Layer (Layer 2; narrowband enhancement layer) adds 2 bits per sample (16 kbit/s) in the lower band to enhance the signal quality in this band. Finally, the third Layer (Layer 3; wideband extension layer) encodes the higher band with another 2 bits per sample (16 kbit/s) to produce a wideband synthesis. The structure of the bitstream is embedded. In other words, there is always a Layer 1 after which come either Layer 2 or Layer 3, or both (Layer 2 and Layer 3). In this manner, a synthesized signal of gradually improved quality may be obtained when decoding more layers. For example, FIG. 1 is a schematic block diagram illustrating the structure of the G.711 WBE encoder, FIG. 2 is a schematic block diagram illustrating the structure of the G.711 WBE decoder, and FIG. 3 is a schematic diagram illustrating the composition of an example of embedded structure of the bitstream with multiple layers of the G.711 WBE codec.

ITU-T Recommendation G.711, also known as a companded pulse code modulation (PCM), quantizes each input sample using 8 bits. The amplitude of the input signal is first compressed using a logarithmic law, uniformly quantized with 7 bits (plus 1 bit for the sign), and then expanded to bring it back to the linear domain. The G.711 standard defines two compression laws, the μ-law and the A-law. ITU-T Recommendation G.711 was designed specifically for narrowband input signals in the telephony bandwidth, i.e. 200-3400 Hz. When it is applied to signals in the bandwidth 50-4000 Hz, the quantization noise is annoying and audible especially at high frequencies (see FIG. 4). Thus, even if the upper band (4000-7000 Hz) of the embedded G.711 WBE is properly coded, the quality of the synthesized wideband signal could still be poor due to the limitations of legacy G.711 to encode the 0-4000 Hz band. This is the reason why Layer 2 was added in the G.711 WBE standard. Layer 2 brings an improvement to the overall quality of the narrowband synthesized signal as it decreases the level of the residual noise in Layer 1. On the other hand, this may result in an unnecessarily higher bit rate and extra complexity. Also, this does not solve the problem of audible noise when decoding only Layer 1 or only Layer 1+Layer 3.

### OBJECT OF THE INVENTION

An object of the present invention is therefore to provide a device and method for noise shaping, in particular but not exclusively in a multilayer embedded codec interoperable with the ITU-T Recommendation G.711.

### SUMMARY OF THE INVENTION

More specifically, in accordance with the present invention, there is provided a method for shaping noise during encoding of an input sound signal, the method comprising: pre-emphasizing the input sound signal to produce a pre-emphasized sound signal; computing a filter transfer function in relation to the pre-emphasized sound signal; and shaping the noise by filtering the noise through the computed filter transfer function to produce a shaped noise signal, wherein the noise shaping comprises producing a noise feedback representative of noise generated by processing of the input sound signal through a given sound signal codec.

The present invention also relates to a method for shaping noise during encoding of an input sound signal, the method comprising: receiving a decoded signal from an output of a given sound signal codec supplied with the input sound signal; pre-emphasizing the decoded signal to produce a pre-emphasized signal; computing a filter transfer function in relation to the pre-emphasized signal; and shaping the noise by filtering the noise through the computed filter transfer function, wherein the noise shaping further comprises producing a noise feedback representative of noise generated by processing of the input sound signal through a given sound signal codec.

The present invention is also concerned with a method for noise shaping in a multilayer encoder and decoder, including at least Layer 1 and Layer 2, the method comprising:

at the encoder: producing an encoded sound signal in Layer 1, wherein producing an encoded sound signal comprises shaping noise in Layer 1; producing an enhancement signal in Layer 2; and
at the decoder: decoding the encoded sound signal from Layer 1 of the encoder to produce a synthesis sound signal; decoding the enhancement signal from Layer 2; computing a filter transfer function in relation to the synthesis sound signal; filtering the decoded enhancement signal of Layer 2 through the computed filter transfer function to produce a filtered enhancement signal of Layer 2; and adding the filtered enhancement signal of Layer 2 to the synthesis sound signal to produce an output signal including contributions from both Layer 1 and Layer 2.

The present invention further relates to a device for shaping noise during encoding of an input sound signal, the device comprising: means for pre-emphasizing the input sound signal so as to produce a pre-emphasized signal; means for computing a filter transfer function in relation to the pre-emphasized sound signal; means for producing a noise feedback representative of noise generated by processing of the input sound signal through a given sound signal codec; and means for shaping the noise by filtering the noise feedback through the computed filter transfer function to produce a shaped noise signal.

The present invention is further concerned with a device for shaping noise during encoding of an input sound signal, the device comprising: a first filter for pre-emphasizing the input sound signal so as to produce a pre-emphasized signal; a feedback loop for producing a noise feedback representative of noise generated by processing of the input sound signal through a given sound signal codec; and a second filter having a transfer function determined in relation to the pre-emphasized signal, this second filter processing the noise feedback to produce a shaped noise signal.

The present invention still further relates to a device for shaping noise during encoding of an input sound signal, the device comprising: means for receiving a decoded signal from an output of a given sound codec supplied with the input sound signal; means for pre-emphasizing the decoded signal so as to produce a pre-emphasized signal; means for calculating a filter transfer function in relation to the pre-emphasized signal; means for producing a noise feedback representative of noise generated by processing of the input sound signal through the given sound signal codec; and means for shaping the noise by filtering the noise feedback through the computed filter transfer function.

The present invention is still further concerned with a device for shaping noise during encoding of an input sound signal, the device comprising: a receiver of a decoded signal from an output of a given sound signal codec; a first filter for pre-emphasizing the decoded signal to produce a pre-emphasized signal; a feedback loop for producing a noise feedback representative of noise generated by processing of the sound signal through the given sound signal codec; and a second filter having a transfer function determined in relation to the pre-emphasized signal, this second filter processing the noise feedback to produce a shaped noise signal.

The present invention further relates to a device for shaping noise in a multilayer encoder and decoder, including at least Layer 1 and Layer 2, the device comprising:

at the encoder: means for encoding a sound signal, wherein the means for encoding the sound signal comprises means for shaping noise in Layer 1; and means for producing an enhancement signal from Layer 2;
at the decoder: means for decoding the encoded sound signal from Layer 1 so as to produce a synthesis signal from Layer 1; means for decoding the enhancement signal from Layer 2; means for calculating a filter transfer function in relation to the synthesis sound signal; means for filtering the enhancement signal to produce a filtered enhancement signal of Layer 2; and means for adding the filtered enhancement signal of Layer 2 to the synthesis sound signal so as to produce an output signal including contributions of both Layer 1 and Layer 2.

The present invention is further concerned with a device for shaping noise in a multilayer encoding device and decoding device, including at least Layer 1 and Layer 2, the device comprising:

at the encoding device: a first encoder of a sound signal in Layer 1, wherein the first encoder comprises a filter for shaping noise in Layer 1; and a second encoder of an enhancement signal in Layer 2; and
at the decoding device: a decoder of the encoded sound signal to produce a synthesis sound signal; a decoder of the enhancement signal in Layer 2; a filter having a transfer function determined in relation to the synthesis sound signal from Layer 1, this filter processing the decoded enhancement signal to produce a filtered enhancement signal of Layer 2; and an adder for adding the synthesis sound signal and the filtered enhancement signal to produce an output signal including contributions of both Layer 1 and Layer 2.

The foregoing and other objects, advantages and features of the present invention will become more apparent upon reading of the following non restrictive description of illustrative embodiments thereof, given by way of example only with reference to the accompanying drawings.

### BRIEF DESCRIPTION OF THE DRAWINGS

In the appended drawings:

FIG. 1 is a schematic block diagram of the G.711 wideband extension encoder;

FIG. 2 is a schematic block diagram of the G.711 wideband extension decoder;

FIG. 3 is a schematic diagram illustrating the composition of the embedded bitstream with multiple layers in the G.711 WBE codec;

FIG. 4 is a graph illustrating speech and noise spectra in PCM coding without noise shaping;

FIG. 5 is a schematic block diagram illustrating perceptual shaping of an error signal in the AMR-WB codec;

FIG. 6 is a schematic block diagram illustrating pre-emphasis and noise shaping in the G.711 framework;

FIG. 7 is a simplified schematic block diagram showing pre-emphasis and noise shaping, this block diagram being equivalent to the schematic block diagram of FIG. 6;

FIG. 8 is a schematic block diagram illustrating noise shaping maintaining interoperability with the legacy G.711 decoder;

FIG. 9 is a schematic block diagram illustrating noise shaping maintaining interoperability with the legacy G.711 using a perceptual weighting filter in the same manner as in the AMR-WB;

FIGS. 10a, 10b, 10c and 10d are schematic block diagrams illustrating transformation of the noise shaping scheme interoperable with the legacy G.711 decoder;

FIG. 11 is a schematic block diagram of the structure of the final noise shaping scheme maintaining interoperability with the legacy G.711 and using a perceptual weighting filter in the same manner as in the AMR-WB;

FIG. 12 is a graph illustrating speech and noise spectra in the PCM coding with noise shaping;

FIG. 13 is a schematic block diagram illustrating the structure of a two-layer G.711-interoperable encoder with noise shaping; and

FIG. 14 is a schematic block diagram of a detailed structure of a two-layer G.711-interoperable encoder with noise shaping;

FIG. 15 is a schematic block diagram of a detailed structure of a two-layer G.711-interoperable decoder with noise shaping;

FIGS. 16a and 16b are graphs illustrating the A-law quantizer levels in the G.711 WBE codec with and without a dead-zone quantizer;

FIGS. 17a and 17b are graphs illustrating the μ-law quantizer levels in the G.711 WBE codec with and without the dead-zone quantizer;

FIG. 18 is a schematic block diagram of the structure of a final noise shaping scheme maintaining interoperability with the legacy G.711 similar to FIG. 11 but with a noise shaping filter computed on the basis of the past decoded signal; and

FIG. 19 is a schematic block diagram illustrating the structure of a two-layer G.711-interoperable encoder with noise shaping similar to FIG. 13 but with a noise shaping filter computed on the basis of the past decoded signal.

### DETAILED DESCRIPTION

Generally stated, a first non-restrictive illustrative embodiment of the present invention allows for encoding the lower-band signal with significantly improved quality than would be obtained using only the legacy G.711 codec. The idea behind the disclosed, first non-restrictive illustrative embodiment is to shape the G.711 residual noise according to some perceptual criteria and masking effects so that this residual noise is far less annoying for listeners. The disclosed device and method are applied in the encoder and it does not affect interoperability with G.711. More specifically, the part of the encoded bitstream corresponding to Layer 1 can be decoded by a legacy G.711 decoder with increased quality due to proper noise shaping. The disclosed device and method also provide a mechanism to shape the quantization noise when decoding both Layer 1 and Layer 2. This is accomplished by introducing a complementary part of the noise shaping device and method also in the decoder when decoding the information of Layer 2.

In the first non-restrictive illustrative embodiment, similar noise shaping as in the 3GPP AMR-WB standard [2] and ITU-T Recommendation G.722.2 [3] is used. In AMR-WB, a perceptual weighting filter is used at the encoder in the error-minimization procedure to obtain the desired shaping of the error signal.

Furthermore, in the first non-restrictive illustrative embodiment, the weighted perceptual filter is optimized for a multilayer embedded codec interoperable with the legacy ITU-T Recommendation G.711 codec and has a transfer function directly related to the input signal. This transfer function is updated on a frame-by-frame basis. The noise shaping method has a built-in protection against the instability of the closed loop resulting from signals whose energy is concentrated in frequencies close to half of the sampling frequency. The first non-restrictive illustrative embodiment also incorporates a dead-zone quantizer which is applied to signals with very low energy. These low energy signals, when decoded, would otherwise create an unpleasant coarse noise since the dynamics of the disclosed device and method are not sufficient on very low levels. In a multilayer codec, there is also a second layer (Layer 2) which is used to refine the quantization steps of the legacy G.711 quantizer from the first layer (Layer 1). Because of the disclosed device and method, the signal coming from the second layer needs to be properly shaped in the decoder in order to keep the quantization noise under control. This is accomplished by applying a modified noise shaping algorithm also in the decoder. In this manner, both layers would produce a signal with properly shaped spectrum which is more pleasant to the human ear than it would have been using the legacy ITU-T G.711 codec. The last feature of the proposed device and method is the noise gate which is used to suppress an output signal whenever its level decreases below certain threshold. The output signal with a noise gate sounds cleaner between the active passages and thus the burden of listener's concentration is lower.

Before further describing the first non-restrictive illustrative embodiment of the present invention, the AMR-WB (Adaptive Multi Rate—Wideband) standard will be described.

### 1. Perceptual Weighting in AMR-WB

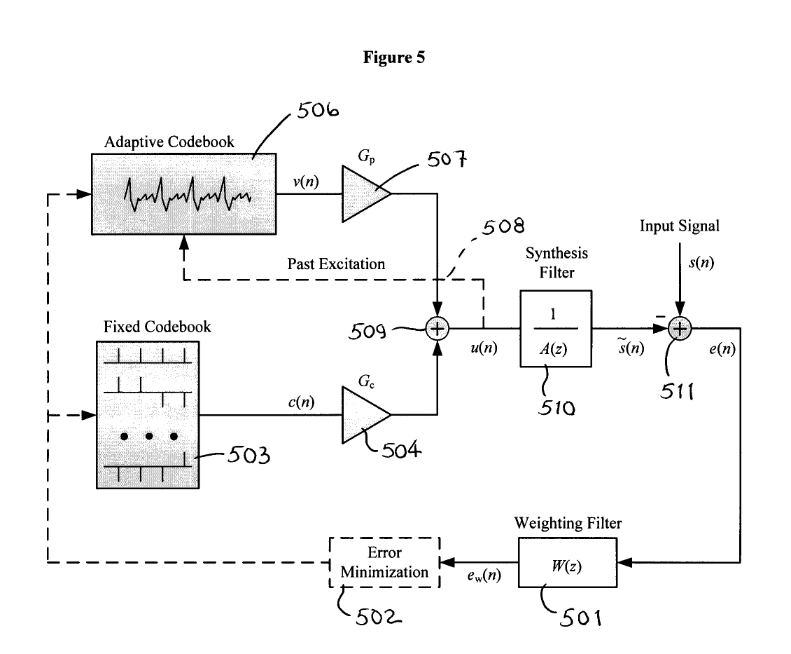

AMR-WB uses an analysis-by-synthesis coding paradigm where the optimum pitch and innovation parameters of an excitation signal are searched by minimizing the mean-squared error between the input sound signal, for example speech, and the synthesized sound signal (filtered excitation) in a perceptually weighted domain (FIG. 5).

As illustrated in FIG. 5, a fixed codebook 503 produces a fixed codebook vector c(n) multiplied by a gain G_{c}. By means of an adder 509, the fixed codebook vector c(n) multiplied by the gain G_{c} is added to the adaptive codebook vector v(n) multiplied by the gain Gₚ to produce an excitation signal u(n). The excitation signal u(n) is used to update the memory of the adaptive codebook 506 and is supplied to the synthesis filter 510 to produce a weighted synthesis sound signal \tilde{s}(n). The weighted synthesis sound signal \tilde{s}(n) is subtracted from the input sound signal s(n) to produce an error signal e(n) supplied a weighting filter 501. The weighted error e_{w}(n) from the filter 501 is minimized through an error minimiser 502; the process is repeated (analysis-by-synthesis) with different adaptive codebook and fixed codebook vectors until the error signal e_{w}(n) is minimized.

This is equivalent to minimizing the error e(n) between the weighted input sound signal s(n) and the weighted synthesis sound signal \tilde{s}(n). The weighting filter 501 has a transfer function W′(z) in the form:

$${W}^{′} ( z ) = \frac{A ( z / {γ}_{1} )}{A ( z / {γ}_{2} )} , where 0 < {γ}_{2} < {γ}_{1} \leq 1 \qquad ( 1 )$$

where A(z) represents a linear prediction (LP) filter, and γ₂,γ₁ are weighting factors. Since the sound signal is quantized in the weighted domain, the spectrum of the quantization noise in the weighted domain is flat, which can be written as:

E_{w}(z)=W′(z)E(z) (2)

where E(z) is the spectrum of the error signal e(n) between the input sound signal and the synthesized sound signal \tilde{s}(n), and E_{w}(z) is the “flat” spectrum of the weighted error signal e_{w}(n). From Equation (2), it can be seen that the error E(z) between the input sound signal and synthesis sound signal is shaped by the inverse of the weighting filter, that is E(z)=W′(z)⁻¹ E_{w}(z). This result is described in Reference [4]. The transfer function W′(z)⁻¹ exhibits some of the formant structure of the input sound signal. Thus, the masking property of the human ear is exploited by shaping the quantization error so that it has more energy in the formant regions where it will be masked by the strong signal energy present in these regions. The amount of weighting is controlled by the factors γ₁ and γ₂ in Equation (1).

The above described traditional perceptual weighting filter works well with signals in the telephony frequency bandwidth 300-3400 Hz. However, it was found that this traditional perceptual weighting filter is not suitable for efficient perceptual weighting of wideband signals in the frequency bandwidth 50-7000 Hz. It was also found that the traditional perceptual weighting filter has inherent limitations in modelling the formant structure and the required spectral tilt concurrently. The spectral tilt is more pronounced in wideband signals due to the wide dynamic range between low and high frequencies. Prior techniques has suggested to add a tilt filter into W′(z) in order to control the tilt and formant weighting of the wideband input sound signal separately.

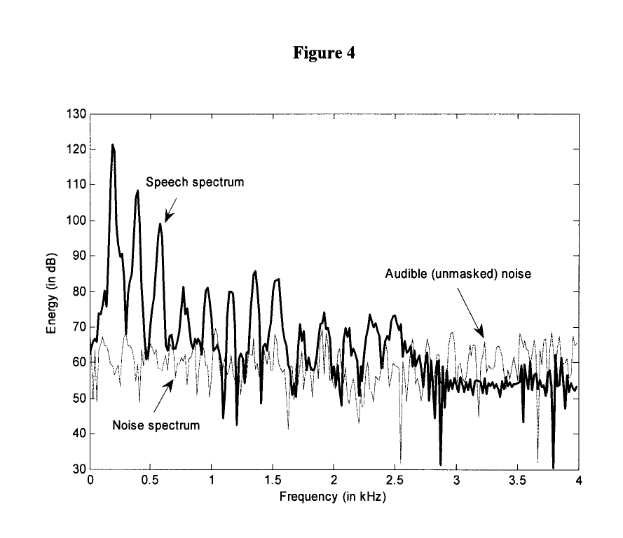

A solution to this problem as described in Reference [5] has been introduced in the AMR-WB standard and comprises applying a pre-emphasis filter at the input, computing the LP filter A(z) on the basis of the sound signal pre-emphasized for example by the filter 1-μz⁻¹, where μ is a pre-emphasis factor, and using a modified filter W′(z) by fixing its denominator. In this particular case the CELP (Code-Excited Linear Prediction) model of FIG. 4 is applied to a pre-emphasized signal, and at the decoder the synthesis sound signal is deemphasized with the inverse of the pre-emphasis filter. LP analysis is performed on the pre-emphasized signal s(n) to obtain the LP filter A(z). Also, a new perceptual weighting filter with a fixed denominator is used which is given by the following relation:

$${W}^{′} ( z ) = \frac{A ( z / {γ}_{1} )}{1 - {γ}_{2} {z}^{- 1}} , where 0 < {γ}_{2} < {γ}_{1} \leq 1 \qquad ( 3 )$$

In Equation (3), a first-order filter is used at the denominator. Alternatively, a higher order filter can also be used. This structure substantially decouples the formant weighting from the spectral tilt. Because A(z) is computed on the basis of the pre-emphasized speech signal s(n), the tilt of the filter 1/A(z/γ₁) is less pronounced compared to the case when A(z) is computed on the basis of the original sound signal. A de-emphasis is performed at the decoder using a filter having a transfer function:

$${P}^{- 1} ( z ) = \frac{1}{1 - μ {z}^{- 1}} \qquad ( 4 )$$

where μ is a pre-emphasis factor. Using a noise shaping approach as Equation (3), the quantization error spectrum is shaped by a filter having a transfer function 1/W′(z)P(z). When γ₂ is set equal to μ, which is typically the case, the weighting filter becomes:

$${W}^{′} ( z ) = \frac{A ( z / γ )}{1 - μ {z}^{- 1}} , where 0 < γ \leq 1 \qquad ( 5 )$$

and the spectrum of the quantization error is shaped by a filter whose transfer function is 1/A(z/γ), with A(z) computed on the basis of the pre-emphasized sound signal. Subjective listening showed that this structure for achieving the error shaping by a combination of pre-emphasis and modified weighting filtering is very efficient for encoding wideband signals, in addition to the advantages of ease of fixed-point algorithmic implementation.

Although the noise shaping described above is used in AMR-WB with wideband signals whose frequency bandwidth is 50-7000 Hz, it also works well when the bandwidth is limited to 50-4000 Hz which is the case of the first non restrictive illustrative embodiment and the G.711 WBE codec (Layer 1 and Layer 2).

2. Perceptual Weighting in a Multilayer Embedded Codec Interoperable with the ITU-T G.711 Standard

### 2.1. Perceptual Weighting of Noise in the First Layer (Core Layer)

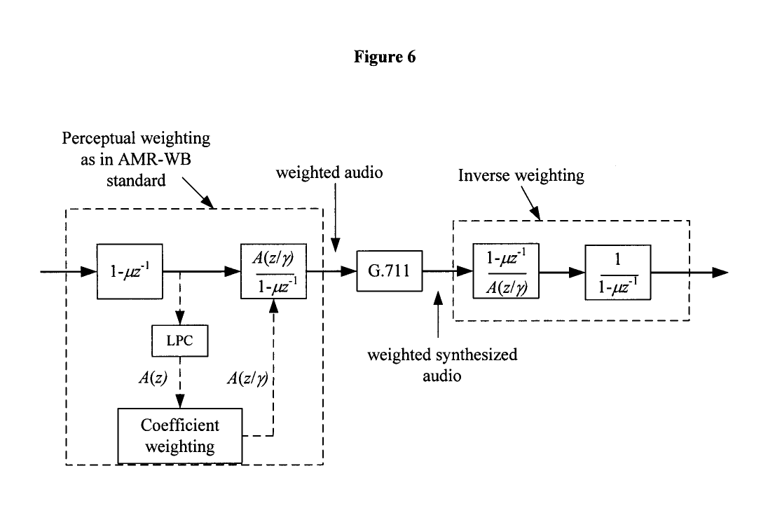

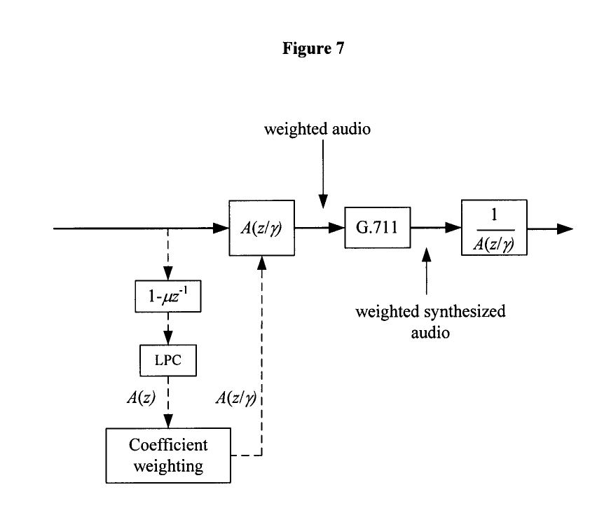

FIG. 6 shows an example of a single-layer encoder based on the ITU-T Recommendation G.711 (e.g. Layer 1 of the G.711 WBE codec) where the quantization error is shaped by a filter 1/A(z/γ), with A(z) computed on the basis of the input sound signal pre-emphasized using the filter 1-μz⁻¹. FIG. 7 is a simplification of FIG. 6 where the pre-emphasis filter and the weighting filter are combined, but the LP filter is still computed on the basis of the sound signal pre-emphasized for example by the filter 1-μz⁻¹ as in FIG. 6. From both FIGS. 6 and 7 it is clear that the G.711 quantization error which has usually a flat spectrum is shaped by the filter 1/A(z/γ), with A(z) computed on the basis of pre-emphasized input sound signal. Although the configurations in FIG. 6 and FIG. 7 both achieve the desired noise shaping, they do not result in an encoder interoperable with the legacy G.711 decoder. This is due to the fact that the inverse weighting filter must be applied at the decoder output.

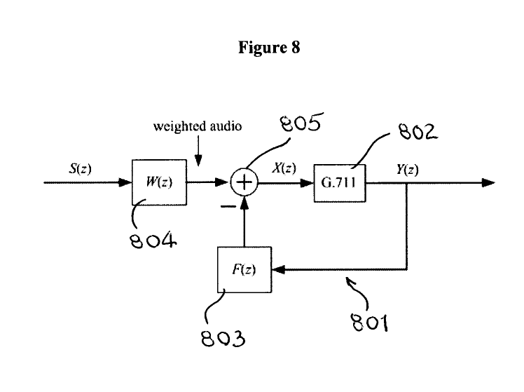

In FIG. 8, a different noise-shaping scheme is shown, which bypasses the need of applying the inverse weighting at the decoder. Thus, the scheme in FIG. 8 maintains interoperability with legacy G.711 decoder. This is achieved by introducing a noise feedback 801 at the input of the G.711 quantizer 802. The feedback loop 801 of FIG. 8 supplies the output signal Y(z) from the G.711 decoder 802 to an adder 805 through a generic filter F(z) 803 which can be structured in different ways. The transfer function of this filter 803 in an illustrative example is further described in the present specification. The filtered signal from the filter 803 is subtracted from the signal S(z) weighted by the weighting filter 804 to supply an input signal X(z) to the input of the G.711 quantizer 802. In FIG. 8 the following relations are observed:

X(z)=S(z)W(z)−Y(z)F(z) (6a)

Y(z)=X(z)+Q(z) (6b)

where X(z) is the input sound signal of the G.711 quantizer 802, S(z) is the original sound signal, Y(z) is the output signal of the G.711 quantizer 802, Q(z) is the G.711 quantization error with flat spectrum and W(z) is the transfer function of the weighting filter 804. The above Equations 6a and 6b yield:

Y(z)=S(z)W(z)−Y(z)F(z)+Q(z) (7)

which leads to:

Y(z)[1+F(z)]=S(z)W(z)+Q(z) (8)

This is equivalent to:

$$Y ( z ) = \frac{S ( z ) W ( z )}{1 + F ( z )} + \frac{Q ( z )}{1 + F ( z )} \qquad ( 9 )$$

Therefore, by choosing F(z)=W(z)−1, the following relation can be obtained:

$$Y ( z ) = S ( z ) + \frac{Q ( z )}{W ( z )} \qquad ( 10 )$$

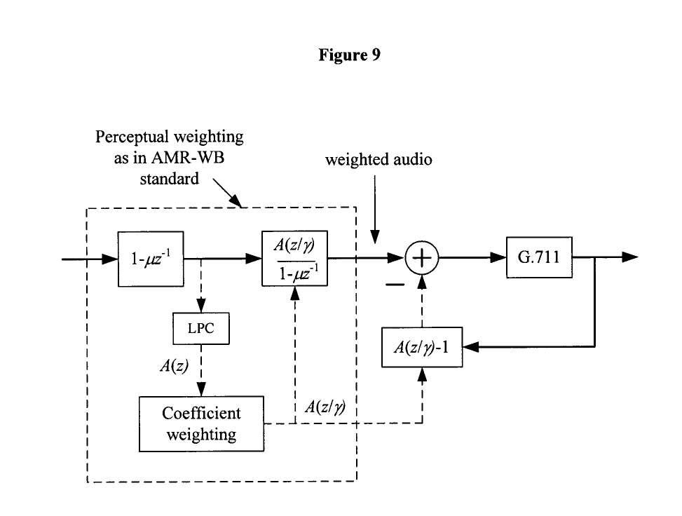

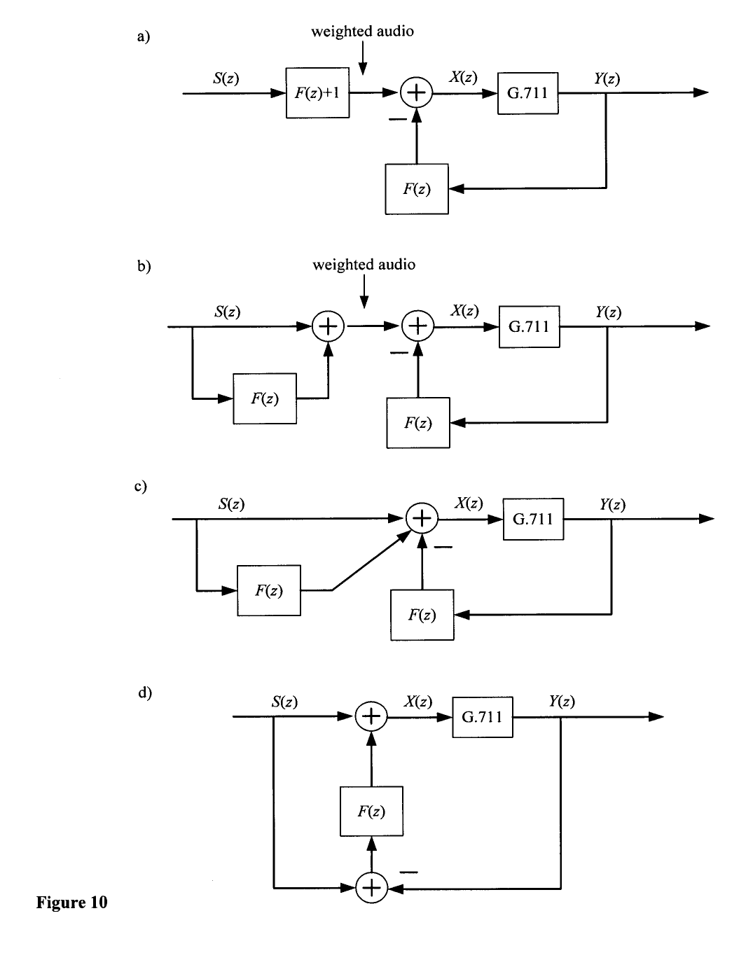

Thus, the error between the output (synthesis) sound signal Y(z) and the input sound signal S(z) is shaped by the inverse of the weighting filter W(z). FIG. 9 is identical to FIG. 8 but with the perceptual weighting filter used in AMR-WB. That is, the weighting filter W(z) 804 of FIG. 8 is set as W(z)=A(z/γ), with A(z) computed on the basis of the pre-emphasized signal. Returning back to FIG. 8 and setting F(z)=W(z)−1, it can be seen that this configuration can be reduced to that of FIG. 10d with no change of functionality. The transformation is shown in FIGS. 10a-10d. Considering first FIG. 10a, which is obtained by replacing W(z) by F(z)+1 in FIG. 8. This is of course the same as setting F(z)=W(z)−1. Filter F(z)+1 can then be replaced by filter F(z) in parallel with filter “1” (i.e. a transfer function equal to 1) whose outputs are summed, as shown in FIG. 10b. The two summations of FIG. 10b can be replaced by a single summation with three inputs, as shown in FIG. 10c. Two of these inputs have positive signs and the third has a negative sign. Since filter F(z) is linear, it can be shown that FIG. 10c is equivalent to FIG. 10d. Indeed, with a linear filter, adding (or subtracting) two inputs before filtering is equivalent to filtering the individual inputs (as shown in FIG. 10c) and then adding (or subtracting) the filter outputs. From FIG. 10d, it can be written:

X(z)=S(z)+F(z)[S(z)−Y(z)] (11a)

Y(z)=X(z)+Q(z) (11b)

Thus,

Y(z)=S(z)+F(z)[S(z)−Y(z)]+Q(z) (12)

which leads to:

Y(z)[1+F(z)]=S(z)[1+F(z)]+Q(z) (13)

### Therefore,

$$Y ( z ) = S ( z ) + \frac{Q ( z )}{1 + F ( z )} \qquad ( 14 )$$

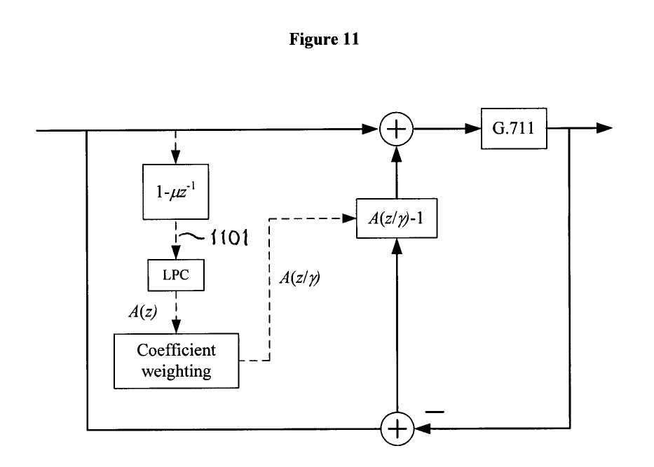

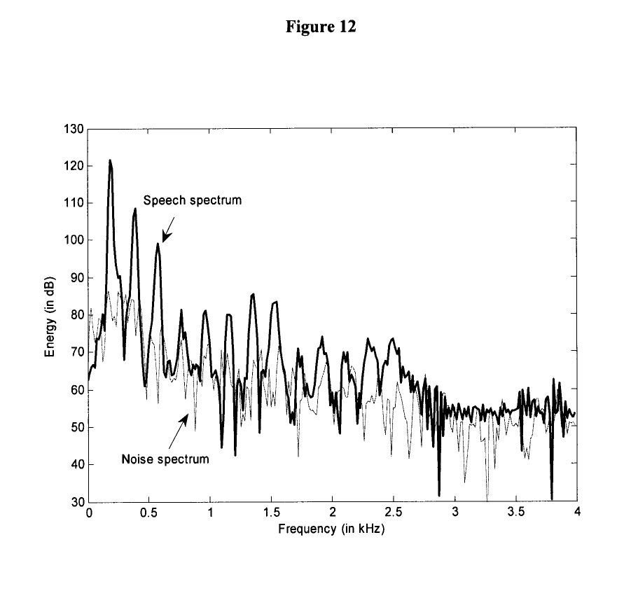

Thus, by setting F(z)=W(z)−1, the same error shaping as in FIG. 8 is achieved, but with fewer filtering operations, therefore resulting in a reduction in complexity. FIG. 11 is identical to FIG. 10d but with the error shaping used in AMR-WB. More specifically, the shaping filter W(z) is set to W(z)=A(z/γ), with A(z) computed on the basis of the pre-emphasized sound signal 1101 so that the quantization error is shaped by a filter 1/A(z/γ). Then, the filter F(z) in FIG. 10d is set to W(z)−1, respectively A(z/γ)−1. FIG. 12 shows the spectrum of the same signal as in FIG. 4, but after applying the noise shaping in the configuration of FIG. 11. It can be clearly seen in FIG. 12 that the quantization noise at high frequency is properly masked by the signal.

The pre-emphasis factor μ which is used in FIG. 11 can be fixed or adaptive. In the first non-restrictive illustrative embodiment, an adaptive pre-emphasis factor μ is used which is signal-dependent. A zero-crossing rate c is calculated for this purpose on the input sound signal. The zero-crossing rate c is calculated on the past and present frame, respectively s(n−1) and s(n), using the following relation:

$$c = \frac{1}{2} {\sum }_{n = - N + 1}^{N - 1} \vert sgn [ s ( n - 1 ) ] + sgn [ s ( n ) ] \vert \qquad ( 15 )$$

where N is the size or length of the frame.
The pre-emphasis factor μ is given by the following relation:

$$μ = 1 - \frac{256}{32767} c . \qquad ( 16 )$$

This results in the range 0.38<μ<1.0. In this manner, the pre-emphasis is stronger for harmonic signals and weaker for noise.

In summary, the noise shaping filter W(z) is given by W(z)=A(z/γ), with A(z) computed on the basis of the pre-emphasized sound signal, where the pre-emphasis is performed using an adaptive pre-emphasis factor μ as described in Equations (15) and (16).

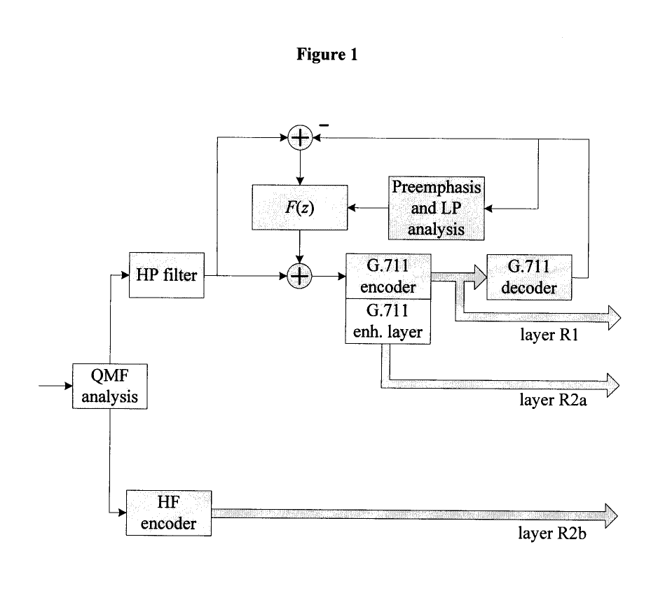

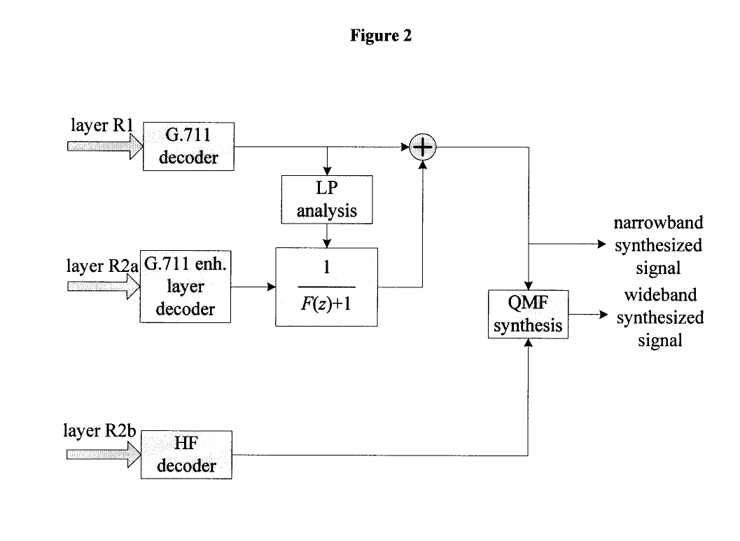

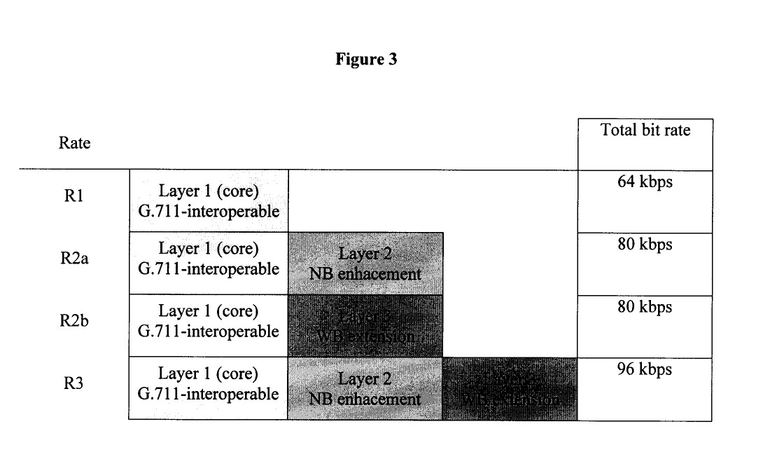

In the foregoing first non-restrictive illustrative embodiment, the computation of the filter W(z)=A(z/γ) (pre-emphasis and LP analysis) is based on the input sound signal. In a second non-restrictive illustrative embodiment, the filter is computed based on the decoded signal from Layer 1. As will be described herein below, in an embedded coding structure, in order to perform the same noise shaping on the second narrowband enhancement layer, Layer 2 for example, a device and method is disclosed whereby the decoded signal from the second layer is filtered through the filter 1/W(z). Thus pre-emphasis and LP analysis should also be performed at the decoder, where only the past decoded signal is available. Therefore, in order to minimize the difference with the noise-shaping filter calculated in the decoder, the filter calculated at the encoder can be based on the past decoded signal from Layer 1, which is available at both the encoder and the decoder. This second non-restrictive illustrative embodiment is employed in the ITU-T Recommendation G.711 WBE standard (see FIG. 1).

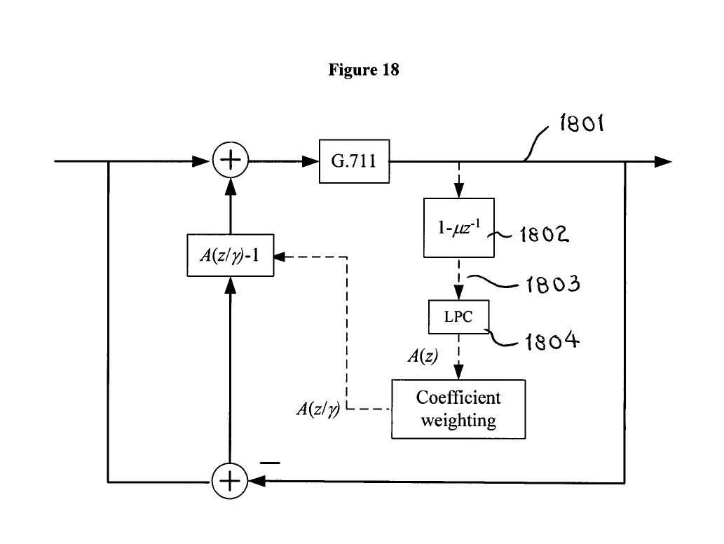

FIG. 18 shows the noise shaping scheme maintaining interoperability with the legacy G.711 similar to FIG. 11 but with the noise shaping filter computed on the basis of the past decoded signal. Pre-emphasis is first performed on the past decoded signal 1801 in the pre-emphasizing unit 1802. In the second non-restrictive illustrative embodiment, the decoded signal from the last two frames (y(n), n=−2N, . . . , −1) is used. The pre-emphasis factor is given by μ=1−0.0078c where the zero-crossing rate c is given by the following relation:

$$c = \frac{1}{2} {\sum }_{n = - 2 N + 1}^{- 1} \vert sgn [ y ( n - 1 ) ] + sgn [ y ( n ) ] \vert$$

where the negative index represents past signal. LP analysis is then performed on the pre-emphasized past signal 1803.

In the second non-restrictive illustrative embodiment, for example, a 4th order LP analysis is conducted once per frame using an asymmetric window. The window is divided in two parts: the length of the first part is 60 samples and the length of the second part is 20 samples. The window is given by the relation:

$$w ( n ) = \{ \begin{matrix}0 & n = 0 \\ \begin{matrix}0.5 cos ( ( n + 0.5 ) \frac{π}{2 {L}_{1}} - \frac{π}{2} ) + \\ 0.5 {cos}^{2} ( ( n + 0.5 ) \frac{π}{2 {L}_{1}} - \frac{π}{2} )\end{matrix} & n = 1 , … , {L}_{1} - 1 \\ \begin{matrix}.5 cos ( ( n - {L}_{1} + 0.5 ) \frac{π}{2 {L}_{2}} ) + \\ 0.5 {cos}^{2} ( ( n - {L}_{1} + 0.5 ) \frac{π}{2 {L}_{2}} )\end{matrix} & n = {L}_{1} , … , {L}_{1} + {L}_{2} - 1\end{matrix} \}$$

where the values L₁=60 and L₂=20 are used (L₁+L₂=2N=80). The past decoded signal y(n) is pre-emphasized and windowed to obtain the signal s′ (n), n=0, . . . , 2N−1. The autocorrelations r(k) of the windowed signal s′(n), n=0, . . . , 79 are computed using the following relation:

$$r ( k ) = {\sum }_{n = k}^{79} {s}^{′} ( n ) {s}^{′} ( n - k ) , k = 0 , … , 4 ,$$

and a 120 Hz bandwidth expansion is used by lag-windowing the autocorrelations using the window:

$${w}_{lag} ( i ) = exp [ - \frac{1}{2} {( \frac{2 π {f}_{0} i}{{f}_{s}} )}^{2} ]$$

$$i = 1 , … , 4 ,$$

where f₀=120 Hz is the bandwidth expansion and fₛ=8000 Hz is the sampling frequency. Furthermore, r(0) is multiplied by the white noise correction factor 1.0001 which is equivalent to adding a noise floor at −40 dB.

The modified autocorrelations are used in the LPC analyser 1804 to obtain the LP filter coefficients aₖ, k=1, . . . , 4 by solving the following set of equations:

$${\sum }_{k = 1}^{4} {a}_{k} {r}^{′} ( \vert i - k \vert ) = - {r}^{′} ( i ) , i = 1 , … , 4 ,$$

The above set of equations is solved using the Levinson-Durbin algorithm well-known to those of ordinary skill in the art.

### 2.2. Perceptual Weighting of Noise in a Multi-Layer Scheme (Encoder Part)

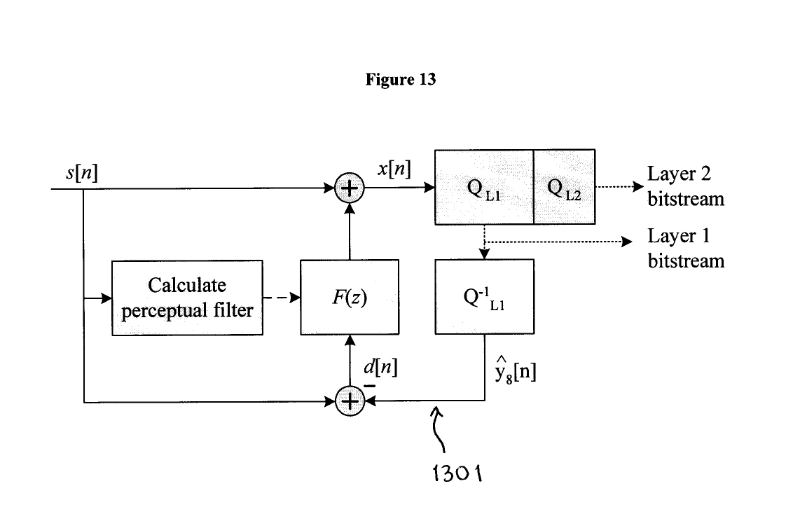

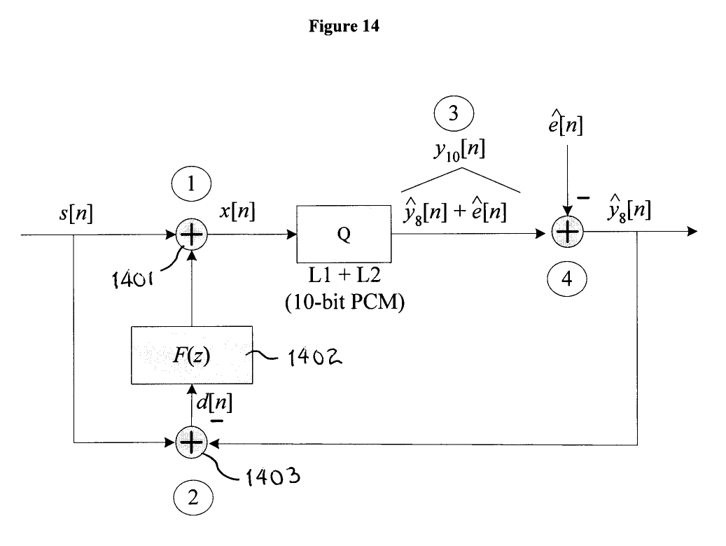

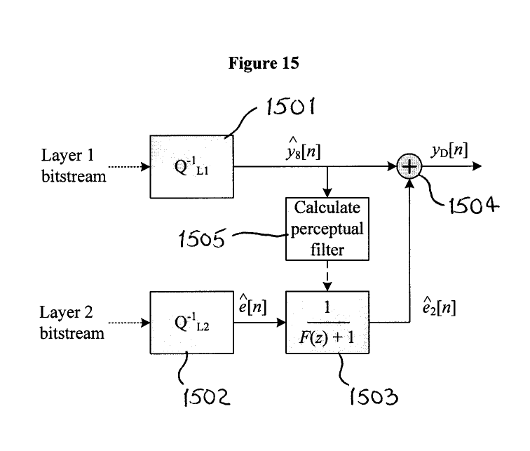

The above description describes how the coding noise in a single-layer G.711-compatible encoder is shaped. To ensure proper noise shaping when multiple layers are used, the noise shaping algorithm is distributed between the encoder (for the first or core layer) in FIGS. 13 and 14 and the decoder (for the upper layers such as Layer 2 in G.711 WBE) in FIG. 15.

FIG. 13 shows the encoder side of the algorithm when two (2) layers are used. Q_{L1} and Q_{L2} are the quantizers of Layer 1 and Layer 2, respectively. In the G.711 WBE standard, Layer 1 corresponds to G.711 compatible encoding at 8 bits/sample (with noise shaping at the encoder) and Layer 2 corresponds to the lower band enhancement layer at 2 bits/sample. FIG. 13 shows that the noise feedback loop 1301 for noise shaping is applied using only the past synthesis signal from Layer 1 (ŷ₈(n)). This ensures that the coding noise from Layer 1 only is properly shaped. Then, the Layer 2 encoder (Q_{L2}) is applied directly to refine Layer 1. Noise shaping for this Layer 2 (and possible other upper layers above Layer 2) will be applied at the decoder, as described below.

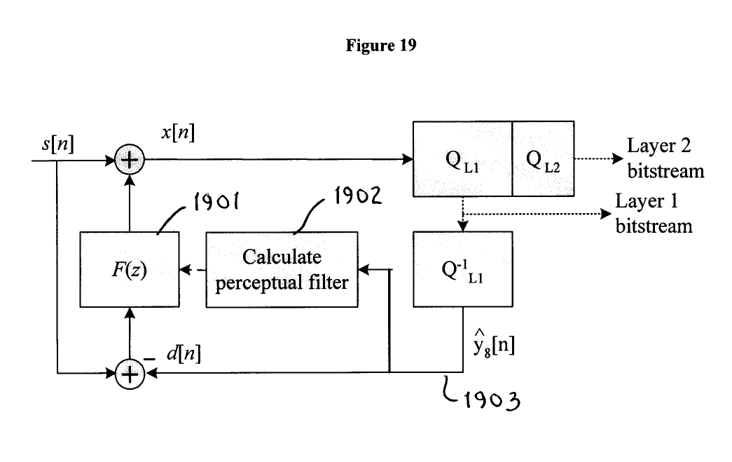

FIG. 19 shows the structure of a two-layer G.711-interoperable encoder with noise shaping similar to FIG. 13 but with the noise shaping filter 1901 computed in filter calculator 1902 based on the past decoded signal 1903.

Conceptually, FIGS. 13 and 19 are equivalent to FIG. 14. In FIG. 14, the algorithm is decomposed in 4 operations, numbered 1 to 4 (circled). At time n, an input sample s[n] is added to the filtered difference signal d[n]. Hence, in the z-transform domain, the output X(z) of the adder 1401 of Operation 1 in FIG. 14 can be written as follows:

X(z)=S(z)+F(z)D(z) (17)

As before, filter F(z) 1402 is defined as F(z)=W(z)−1, where for example W(z)=A(z/γ) is the weighted LP filter, with A(z) calculated on the pre-emphasized sound signal (speech or audio). The difference signal d[n] from Operation 2 in FIG. 14 is produced by the adder 1403 and is expressed, in the z-transform domain, as:

D(z)=S(z)−Ŷ₈(z) (18)

Here, Ŷ₈(z) (or ŷ₈ [n] in the time domain) is the quantized output from the first Layer (8-bit PCM in the G.711 WBE codec). Thus, the noise feedback in FIG. 14 takes only into consideration the output of Layer 1. Still referring to FIG. 14, the signal x[n], i.e. the input modified by the noise feedback, is quantized in the quantizer Q. This quantizer Q produces the 8-bits of Layer 1 (which can be decoded into ŷ₈ [n]), plus the 2 enhancement bits of Layer 2 (which can be decoded to form ê[n]). In Operation 3, y₁₀ [n] is defined as the sum of ŷ₈ [n] and ê[n], yielding the following relation:

Y₁₀(z)=X(z)+Q(z) (19)

where Q(z) (or q[n] in the time domain) is the quantization noise from block Q. This is a quantization noise from a 10-bit PCM quantizer, since both Layer 1 and Layer 2 bits are obtained from Q. In a multilayer encoder, such as the G.711 WBE encoder, these 10 bits actually correspond to 8 bits from Layer 1 (PCM-compatible) plus 2 bits from Layer 2 (enhancement Layer).

In FIG. 14, to ensure that the noise feedback comes only from Layer 1, Operation 4 subtracts ê[n] from y₁₀ [n] to yield ŷ₈ [n] again:

Ŷ₈(z)=Y₁₀(z)−Ê(z) (20)

In practice, Operation 4 would not be performed explicitly. The bits from the Layer 1 part of box Q in FIG. 14 are used to decode ŷ₈ [n], and the additional 2 bits from Layer 2 are just packed and sent to the channel. When decoding Layer 1 bits only, the following input/synthesis relationship is provided:

$${\hat{Y}}_{8} ( z ) = S ( z ) + \frac{{Q}_{8} ( z )}{W ( z )} \qquad ( 21 )$$

where Q₈(z) is the quantization noise from Layer 1 only (core 8-bit PCM). This is the desired noise shaping result for that core Layer (or Layer 1).

### 2.3. Perceptual Weighting of Noise in a Multi-Layer Scheme (Decoder Part)

This section describes how the noise is shaped if both Layer 1 and Layer 2 are decoded, i.e. if the signal y₁₀[n] in FIG. 14 is decoded. Substituting D(z) in Equation (17) with the expression given in Equation (18) yields the following relation:

X(z)=S(z)+F(z){S(z)−Ŷ₈(z)} (22)

In Equation (19), the relationship between X(z) and Y₁₀(z) is provided. By substituting X(z) in Equation (22) the following relation is obtained:

Y₁₀(z)−Q(z)=S(z)+F(z){S(z)−Ŷ₈(z)}. (23)

Now, using Equation (20) to substitute Ŷ₈(z) in the above relation yields the following relation:

Y₁₀(z)−Q(z)=S(z)+F(z){S(z)−Y₁₀(z)+Ê(z)} (24)

Isolating all terms in Y₁₀(z) on the left hand side of the above Equation (24) yields the following relation:

{F(z)+1}Y₁₀(z)={F(z)+1}S(z)+Q(z)+F(z)Ê(z) (25)

Dividing both sides by F(z)+1, the following relation is obtained:

$${Y}_{10} ( z ) = S ( z ) + \frac{Q ( z )}{\{ F ( z ) + 1 \}} + \frac{F ( z )}{\{ F ( z ) + 1 \}} \hat{E} ( z ) \qquad ( 26 )$$

Since we have F(z)=W(z)−1, it can be written:

$${Y}_{10} ( z ) = S ( z ) + \frac{Q ( z )}{W ( z )} + \frac{W ( z ) - 1}{W ( z )} \hat{E} ( z ) . \qquad ( 27 )$$

Let's recall that Q(z) is the coding noise from the 10-bit quantizer Q in FIG. 14, i.e. using both Layer 1 and Layer 2 to encode x[n]. Hence, the desired signal to obtain, when decoding the core layer (Layer 1) and the enhancement layer (Layer 2), is only the part:

$$S ( z ) + \frac{Q ( z )}{W ( z )} \qquad ( 28 )$$

from the right hand side of Equation (27). The term

$$\frac{W ( z ) - 1}{W ( z )} \hat{E} ( z )$$

is therefore undesirable and should be eliminated. It can be written:

$$S ( z ) + \frac{Q ( z )}{W ( z )} = {Y}_{D} ( z ) = {Y}_{10} ( z ) - \frac{W ( z ) - 1}{W ( z )} \hat{E} ( z ) \qquad ( 29 )$$

In the equation above Y_{D}(z) denotes the desired signal when decoding both Layer 1 and Layer 2. Now, Y₁₀(z) is related to Ŷ₈(z) (the Layer 1 synthesis signal) and Ê(z) (the transmitted 2-bit enhancement from Layer 2) in the following manner:

Y₁₀(z)=Ŷ₈(z)+Ê(z) (30)

Using this relationship for Y₁₀ (z) and replacing it in the definition of Y_{D}(z) above yields the following relation:

$${Y}_{D} ( z ) = {\hat{Y}}_{8} ( z ) + \hat{E} ( z ) - \frac{W ( z ) - 1}{W ( z )} \hat{E} ( z ) \qquad ( 31 )$$

The last term in the above Equation (31) can be expanded as follows

$${Y}_{D} ( z ) = {\hat{Y}}_{8} ( z ) + \hat{E} ( z ) - \hat{E} ( z ) + \frac{1}{W ( z )} \hat{E} ( z ) \qquad ( 32 )$$

This finally yields:

$${Y}_{D} ( z ) = {\hat{Y}}_{8} ( z ) + \frac{1}{W ( z )} \hat{E} ( z ) \qquad ( 33 )$$

Equation (33) indicates the operations that have to be performed at the decoder to obtain the Layer 1+Layer 2 synthesis with proper noise shaping. At the encoder side, noise shaping is applied as described in FIG. 14. Only the quantized first layer signal ŷ₈[n] is used (without the contribution of the quantized enhancement layer). At the decoder side, the following is performed:
Compute the Layer 1 synthesis (ŷ₈ [n]) in module 1501;
Compute (decode) the Layer 2 enhancement signal (ê[n]) in module 1502;
Filter ê[n] with a recursive (all-pole) filter

$$\frac{1}{F ( z ) + 1}$$

to form signal ê₂[n] (see filter 1503); and
Sum in adder 1504 the signals ŷ₈[n] and ê₂[n] to form the desired signal y_{D}[n] (sum of Layer 1 and Layer 2 contributions).
   To avoid the transmission of side information, filter W(z)=F(z)+1 is computed at the decoder using the Layer 1 synthesis signal ŷ₈ [n] (see filter calculator 1505). In the G.711 WBE codec, Layer 1 operates at high rate (PCM at 64 kbit/s) so computing this filter at the decoder using Layer 1 does not introduce significant mismatches with the same filter computed at the encoder on the original (input) sound signal. However, to completely avoid the mismatch, the filter W(z) is computed at the encoder using the locally decoded signal ŷ₈ [n] available at both encoder and decoder. This decoding process, to achieve proper noise shaping in Layer 2, is shown in FIG. 15. Similar to the encoder side, W(z)=A(z/γ) where the LP filter A(z) is computed based on the Layer 1 signal after applying adaptive pre-emphasis with pre-emphasis factor adapted according to Equations (15) and (16). In fact in the second non-restrictive illustrative embodiment the same pre-emphasis and 4th order LP analysis performed on the past decoded signal is conducted as described above at the encoder side.

Although the present invention has been described hereinabove by way of non-restrictive illustrative embodiments thereof, these embodiments can be modified without departing from the spirit and nature of the subject invention. For instance, instead of using two (2) bits per sample scalar quantization to quantize the second layer (Layer 2), other quantization strategies can be used such as vector quantization. Furthermore, other weighting filter formulation can be used. In the above illustrative embodiment, the noise shaping is given by W⁻¹(z)=1/A(z/γ). In general, if it is desired to shape the quantization noise by W⁻¹(z), the filter F(z) at the encoder (FIGS. 8 and 10) is given by F(z)=W(z)−1 and, at the decoder, the second layer quantization signal Ê(z) is weighted by W⁻¹(z).

### 2.4. Protection Against Instability of the Noise-Shaping Loop

In some limited cases, e.g. for certain music genres, the energy of a signal may be concentrated in a single frequency peak near 4000 Hz (half of the sampling frequency in the lower band). In this specific case, the noise-shaping feedback becomes unstable since the filter is highly resonant. As a consequence the shaped noise is incorrect and the synthesized signal is clipped. This creates an audible artefact the duration of which may be several frames until the noise-shaping loop returns to its stable state. To prevent this problem the noise-shaping feedback is attenuated whenever a signal whose energy is concentrated in higher frequencies is detected in the encoder.

Specifically, a ratio:

$$r = - \frac{{r}_{1}}{{r}_{0}} . \qquad ( 34 )$$

is calculated where r₀ and r₁ are, respectively, the first and second autocorrelation coefficients. The first autocorrelation coefficient is given by the relation:

$${r}_{0} = \frac{20000}{32767} + {\sum }_{n = - 2 N}^{- 2} {\hat{y}}_{8}^{2} ( n ) \qquad ( 35 )$$

and the second autocorrelation coefficient is calculated using the following relation:

$${r}_{1} = \frac{19000}{32767} + {\sum }_{- 2 N}^{- 2} {\hat{y}}_{8} ( n ) {\hat{y}}_{8} ( n + 1 ) \qquad ( 36 )$$

The ratio r may be used as information about the spectral tilt of the signal. In order to reduce the noise-shaping, the following condition must be fulfilled:

$$r < - \frac{32256}{32767} \qquad ( 37 )$$

The noise-shaping feedback is then modified by attenuating the coefficients of the weighting filter by a factor α in the following manner:

$${F}^{′} ( z ) = W ( z ) - 1 = A ( z / ( α γ ) ) - 1 = {\sum }_{i = 1}^{4} {α}^{i} {γ}^{i} {a}_{i} {z}^{- i} \qquad ( 38 )$$

The attenuation factor α is a function of the ratio r and is given by the relation:

$$a = 16 [ r + \frac{34303}{32767} ] \qquad ( 39 )$$

The attenuation of the perceptual filter for signals whose energy is concentrated in higher frequencies is not activated if there is an active attenuation for signals with very low level. This will be explained in the next section.

### 2.5. Fixed Noise-Shaping Filter for Very-Low Level Signals

When the input signal has a very low energy, the noise-shaping device and method may prevent the proper masking of the coding noise. The reason is that the resolution of the G.711 decoder is level-dependent. When the signal level is too low the quantization noise has approximately the same energy as the input signal and the distortion is close to 100%. Therefore, it may even happen that the energy of the input signal is increased when the filtered noise is added thereto. This in turn increases the energy of the decoded signal, etc. The noise feedback soon becomes saturated for several frames, which is not desirable. To prevent this saturation, the noise-shaping filter is attenuated for very-low level signals.

To detect the conditions for filter attenuation, the energy of the past decoded signal ŷ₈ [n] can be checked if it is below a certain threshold. Note that the correlation r₀ in Equation (35) represents this energy. Thus if the condition

r₀<θ, (40)

is fulfilled, the attenuation for very low level signal is performed, where θ is a given threshold. Alternatively, a normalization factor η_{L} can be calculated on the correlation r₀ in Equation (35). The normalization factor represents the maximum number of left shifts that can be performed on a 16-bit value r₀ to keep the result below 32767. When η_{L} fulfils the condition:

η_{L}≧16, (41)

the attenuation for very low level signal is performed.

The attenuation is carried out on the weighting filter by setting the weighting factor γ=0.5. That is:

$$F ( z ) = ( {\sum }_{i = 1}^{4} {( 0.5 )}^{i} {a}_{i} {z}^{- i} ) . \qquad ( 42 )$$

Attenuating the noise-shaping filter for very-low level input sound signals avoids the case where the noise feedback loop would increase the objective noise level without bringing the benefit of having a perceptually lower noise floor. It also helps to reduce the effects of filter mismatch between the encoder and the decoder.

The perceptual filter attenuations described above (protection against instability or very low level signals) are performed exclusively, which means they cannot be active at the same time. This is explained in the following condition:

### If η_{L}≧16

Do attenuation of the perceptual filter yielding Equation (42).

else if

$$r < - \frac{32256}{32767}$$

Do attenuation of the perceptual filter yielding (38).

else

No attenuation.

end.

### 2.6. Dead-Zone Quantization

Since the noise shaping disclosed in the first and second non-restrictive illustrative embodiments of the invention addresses the problem of noise in PCM encoders, which have fixed (non-adaptive) quantization levels, some very small signal conditions can actually produce a synthesis signal with higher energy than the input. This occurs when the input signal to the quantizer oscillates around the mid-point of two quantization levels.

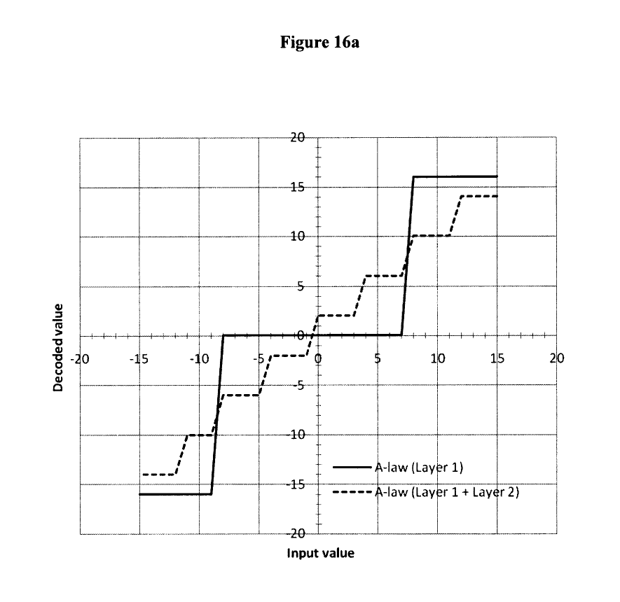

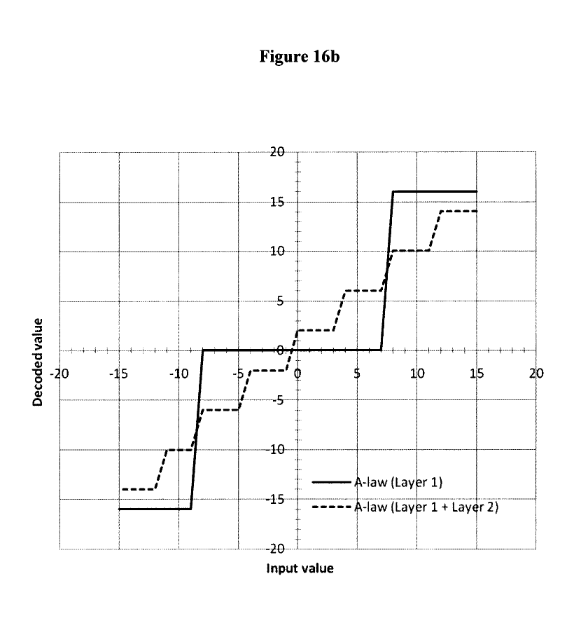

In A-law PCM, the lowest quantization levels are 0 and ±16. Before the quantization, every input sample is offset by the value of +8. If a signal oscillates around the value of 8, every sample with amplitude below 8 will be quantized as 0 and every sample equal or above 8 will be quantized to 16. Then, the quantized signal will toggle between 0 and 16 even though the input sound signal varies only between, say, 6 and 12. This can be further amplified by the recursive nature of the noise shaping. One solution is to increase the region around the origin (0 value) of the quantizer of Layer 1. For example, all values between −11 and +11 inclusively (instead of −7 and +7) will be set to zero by the quantizer in Layer 1. This effectively increases the dead zone of the quantizer, thereby increasing the number of low-level samples which will be set to zero. However, in a multilayer G.711-interoperable encoding scheme, such as the G.711 WBE encoder, there is an extension layer which is used to refine the coarse quantification levels of the core layer (or Layer 1). Therefore, when a dead-zone quantizer is used in Layer 1, it is also necessary to modify the quantization levels of the quantizer in Layer 2. These levels are modified in a way that the error is minimized. One possible configuration of the dead-zone quantization levels for A-law is shown in FIG. 16 in a form of input-output graph. The x-axis represents the input values to the quantizer and the y-axis represents the decoded output values, i.e. when encoded and decoded. The A-law quantization levels corresponding to FIG. 16 are used in the G.711 WBE codec and are also the preferred levels to be used with this method.

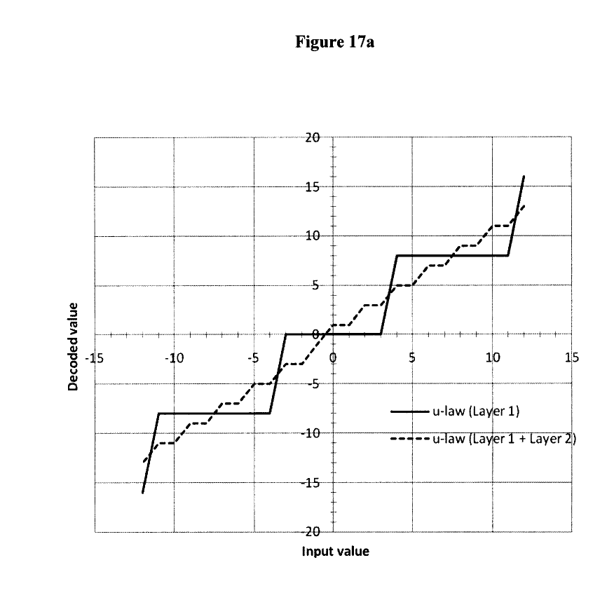

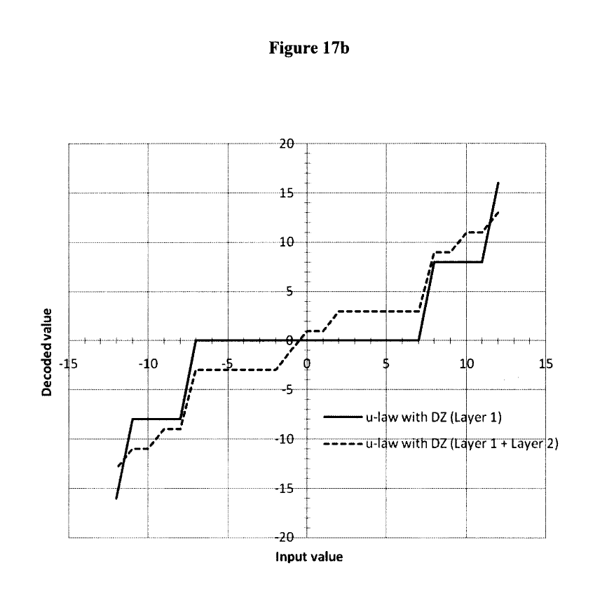

For μ-law, the same principle is followed but with different quantization thresholds (see FIG. 17 for details). In μ-law, there is no offset applied before the quantization but there is an internal bias of 132. Again, the input-output graph in FIG. 17 shows the preferred configuration of the μ-law dead-zone quantization method.

The dead-zone quantizer is activated only when the following condition is satisfied:

$$k \geq 16 and \{ \begin{matrix}s ( n ) ∈ [ - 11 , 11 ] & for A \text{-} law \\ s ( n ) ∈ [ - 7 , 7 ] & for μ \text{-} law\end{matrix} \} . \qquad ( 43 )$$

where k=η_{L} is the same normalization factor as the one used to normalize the value of r₀ in Equation (35). When the condition above is true, the embedded low-band quantizers are not used as well as the core layer decoder. Instead, a different quantization technique is applied, which is explained below. Note that the condition in Equation (40) can be also used to activate the dead-zone quantizer.

As seen in condition (43), the dead-zone quantizer is activated only for extremely low-level input signal s(n), fulfilling the condition (43). The interval of activity is called a dead zone and within this interval the locally decoded core-layer signal y(n) is suppressed to zero. In this dead-zone quantizer, the samples s(n) are quantized according to the following set of equations:

### A Law Case:

u(n)=0

$$v ( n ) = \{ \begin{matrix}0 & s ( n ) ∈ [ - 11 , - 7 ] \\ ( s ( n ) + 8 ) / 2 & s ( n ) ∈ [ - 6 , 7 ] \\ 7 & s ( n ) ∈ [ 8 , 11 ]\end{matrix} \}$$

### μ-Law Case:

u(n)=0

$$v ( n ) = \{ \begin{matrix}0 & s ( n ) ∈ [ - 7 , - 2 ] \\ 2 & s ( n ) = - 1 \\ 4 & s ( n ) ∈ [ 0 , 1 ] \\ 8 & s ( n ) ∈ [ 2 , 7 ]\end{matrix} \}$$

where in the above relations u(n)=ŷ₈(n) is the quantized core layer and v(n)=ê(n) is the quantized second layer.

### 2.7. Noise Gate

To further increase the cleanness of the synthesis signal during quasi-silent periods, a method of a noise gate is added at the decoder. The noise gate attenuates the output signal when the frame energy is very low. This attenuation is progressive in both level and time. The level of attenuation is signal-dependant and is gradually modified on a sample-by-sample basis. In a non limitative example, the noise gate operates in the G.711 WBE decoder as described below.

Before calculating its energy, the synthesised signal in Layer 1 is first filtered by a first-order high-pass FIR filter

y_{f}(n)=y(n)−0.768y(n−1), n=0, 1, . . . , N−1, (34)

where y(n), n=0, . . . , N−1, corresponds to the synthesised signal in the current frame and N=40 is the length of the frame. The energy of the filtered signal is calculated by

$${E}_{0} = {\sum }_{i = 0}^{N - 1} {y}_{f}^{2} ( i ) \qquad ( 35 )$$

In order to avoid fast switching of the noise gate, the energy of the previous frame is added to the energy of the current frame, which gives the total energy

E₁=E₀+E₋₁. (36)

Note that E₋₁ is updated by E₀ at the end of decoding each frame.

Based on the information about signal energy a target gain is calculated as the square root of Eₜ in Equation (36), multiplied by a factor ½⁷, i.e.

$${g}_{t} = \frac{\sqrt{{E}_{t}}}{{2}^{7}}$$

bounded by

0.25≦gₜ≦1.0 (37)

The target gain is lower limited by a value of 0.25 and upper limited by 1.0. Thus, the noise gate is activated when the gain gₜ is less than 1.0. The factor ½⁷ has been chosen such that the signal whose RMS value is ≈20 would result in a target gain gₜ≈1.0 and a signal whose RMS value is ≈5 would result in a target gain gₜ≈0.25. These values have been optimized for the G.711 WBE codec and it is possible to modify them in a different framework.

When the synthesized signal in the decoder has its energy concentrated in the higher band, i.e. 4000-8000 Hz, the noise gate is progressively deactivated by setting the target gain to 1.0. Therefore, a power measure of the lower-band and the higher-band synthesized signals is calculated for the current frame. Specifically, the power of the lower-band signal (synthesized in Layer 1+Layer 2) is given by the following relation:

$${P}_{LB} = {\sum }_{i = 0}^{N} \vert y ( i ) \vert . \qquad ( 38 )$$

The power of the higher-band signal (synthesized in Layer 3) is given by

$${P}_{HB} = {\sum }_{i = 0}^{N} \vert z ( i ) \vert . \qquad ( 39 )$$

where z(n), n=0, . . . , N−1 denotes the synthesized higher-band signal. If Layer 3 is not implemented, the noise gate is not conditioned and is activated every time gₜ is less than 1.0. When Layer 3 is used, the target gain is set to 1.0 every time when P_{HB}>4×10⁻⁷ and P_{HB}>16*P_{LB}.

Finally, each sample of the output synthesized signal (i.e. when both, the lower-band and the higher-band synthesized signals are combined together) is multiplied by a gain:

g(n)=0.99g(n−1)+0.01gₜ, n=0, 1, . . . , N−1 (40)

which is updated on sample-by-sample basis. It can be seen that the gain converges slowly towards the target gain gₜ.

Although the present invention has been described in the foregoing description by means of a non-restrictive illustrative embodiment, this illustrative embodiment can be modified at will within the scope of the appended claims, without departing from the spirit and nature of the subject invention.

### REFERENCES

[1] Pulse code modulation (PCM) of voice frequencies, ITU-T Recommendation G.711, November 1988, (http://www.itu.int).
[2] AMR Wideband Speech Codec: Transcoding Functions, 3GPP Technical Specification TS 26.190 (http://www.3gpp.org).
[3] Wideband coding of speech at around 16 kbit/s using Adaptive Multi-Rate Wideband (AMR-WB), ITU-T Recommendation G.722.2, Geneva, January 2002 (http://www.itu.int).
[4] B. S. Atal and M. R. Schroeder, “Predictive coding of speech and subjective error criteria”, IEEE Trans. of Audio, Speech and Signal Processing, vol. 27, no. 3, pp. 247-254, June 1979.
[5] U.S. Pat. No. 6,807,524 “Perceptual weighting device and method for efficient coding of wideband signals”.

What is claimed is:

1. A method for shaping noise during encoding of an input sound signal, the method comprising:
pre-emphasizing the input sound signal to produce a pre-emphasized sound signal;
computing a filter transfer function in relation to the pre-emphasized sound signal; and
shaping the noise by filtering said noise through the computed filter transfer function to produce a shaped noise signal;
wherein said noise shaping comprises producing a noise feedback representative of noise generated by processing of the input sound signal through a given sound signal codec.

2. A method of noise shaping as defined in claim 1, wherein the given sound signal codec comprises an ITU-T G.711 codec.

3. A method of noise shaping as defined in claim 1, wherein producing the noise feedback comprises computing an error between an output signal from the given sound signal codec and the input sound signal.

4. A method of noise shaping as defined in claim 3, wherein producing the noise feedback comprises supplying the error to an input of the given sound signal codec after filtering of the error through the computed filter transfer function.

5. A method of noise shaping as defined in claim 1, wherein computing the filter transfer function comprises calculating the relation A(z/γ)−1, where A(z) represents a linear prediction filter and γ is a weighting factor.

6. A method of noise shaping as defined in claim 2, wherein the given sound signal codec comprises a multilayer codec.

7. A method of noise shaping as defined in claim 6, wherein the multilayer codec comprises the ITU-T G.711 codec.

8. A method of noise shaping as defined in claim 1, wherein pre-emphasizing the input sound signal comprises processing the input sound signal through a filter having a transfer function 1-μz⁻¹, where μ is a pre-emphasis factor and z represents a z-transform domain.

9. A method of noise shaping as defined in claim 8, wherein the pre-emphasis factor μ is adaptive according to the following relation:
$$μ = 1 - \frac{256}{32767} c$$
with
$$c = \frac{1}{2} {\sum }_{i = - N + 1}^{N - 1} \vert sign [ s ( i - 1 ) ] + sign [ s ( i ) ] \vert ,$$
c being a zero-crossing rate, s(i) being the input sound signal and N being a length of a frame of the input sound signal.

10. A method of noise shaping as defined in claim 8, wherein the pre-emphasis factor μ is situated in a range between 0.38 and 1.

11. A method of noise shaping as defined in claim 8, wherein the pre-emphasis factor μ comprises a fixed value.

12. A method of noise shaping as defined in claim 1, wherein computing the filter transfer function comprises updating the filter transfer function on a frame by frame basis.

13. A method for shaping noise during encoding of an input sound signal, the method comprising:
receiving a decoded signal from an output of a given sound signal codec supplied with the input sound signal;
pre-emphasizing the decoded signal to produce a pre-emphasized signal;
computing a filter transfer function in relation to the pre-emphasized signal; and
shaping the noise by filtering the noise through the computed transfer function;
wherein said noise shaping comprises producing a noise feedback representative of noise generated by processing of the input sound signal through the given sound signal codec.

14. A method of noise shaping as defined in claim 13, wherein the given sound signal codec is an ITU-T G.711 codec.

15. A method of noise shaping as defined in claim 13, wherein the given sound signal codec comprises an ITU-T G.711 multilayer codec, including at least Layer 1 and Layer 2.

16. A method of noise shaping as defined in claim 13, wherein receiving the decoded signal comprises receiving an output signal from Layer 1 of the G.711 multilayer codec.

17. A method of noise shaping as defined in claim 13, wherein computing a filter transfer function comprises calculating the relation A(z/γ)−1, where A(z) is a linear prediction filter and γ is a weighting factor.

18. A method of noise shaping as defined in claim 13, wherein pre-emphasizing the decoded signal comprises processing the decoded signal through a filter having a transfer function 1-μz⁻¹, where μ is a pre-emphasis factor and z represents a z-transform domain.

19. A method of noise shaping as defined in claim 18, wherein the pre-emphasis factor μ is adaptive according to μ=1−0.0078c, where
$$c = \frac{1}{2} {\sum }_{n = - 2 N + 1}^{- 1} \vert sgn [ y ( n - 1 ) ] + sgn [ y ( n ) ] \vert$$
is a zero-crossing rate, y(n) is the decoded signal and N is a length of a frame of the decoded signal.

20. A method of noise shaping as defined in claim 15, further comprising protecting the filter transfer function against instability.

21. A method of noise shaping as defined in claim 20, wherein protecting the filter transfer function against instability comprises detecting signals having an energy concentrated in frequencies close to half of a sampling frequency of the input sound signal.

22. A method of noise shaping as defined in claim 21, wherein detecting the signals having the energy concentrated in the frequencies close to half of the sampling frequency comprises calculating a parameter r reflecting a frequency distribution of the signal energy.

23. A method of noise shaping as defined in claim 22, wherein calculating the parameter r reflecting the frequency distribution of the signal energy comprises calculating an expression
$$r = - \frac{{r}_{1}}{{r}_{0}} ,$$
where r₀ is a first autocorrelation and r₁ is a second autocorrelation of the decoded signal from Layer 1.

24. A method of noise shaping as defined in claim 23, further comprising reducing the noise feedback if r is below a certain threshold.

25. A method of noise shaping as defined in claim 24, wherein reducing the noise feedback comprises reducing the filter transfer function by a factor
$$α = 16 ( 1 + r + \frac{0.75}{16} ) .$$

26. A method of noise shaping as defined in claim 25, wherein reducing the filter transfer function by a factor α comprising calculating an attenuated transfer function A(z/αγ)−1, where A(z) is a linear prediction filter computed on the basis of the pre-emphasized signal and γ is a weighting factor.

27. A method of noise shaping as defined in claim 23, further comprising detecting low energy signals having an energy lower than a given threshold.

28. A method of noise shaping as defined in claim 27, wherein detecting low energy signals having an energy lower than a given threshold comprises protecting the filter transfer function against instability.

29. A method of noise shaping as defined in claim 28, wherein detecting low energy signals comprises computing a normalization factor η_{L} computed in relation to the first autocorrelation r₀.

30. A method of noise shaping as defined in claim 29, further comprising attenuating the filter transfer function when η_{L} is larger than a certain value.

31. A method of noise shaping as defined in claim 27, wherein attenuating the filter transfer function comprises setting a weighting factor γ=0.5, said weighting factor being applied to the filter transfer function.

32. A method of noise shaping as defined in claim 27, further comprising a dead-zone quantization.

33. A method of noise shaping as defined in claim 32, wherein the dead-zone quantization comprises setting a quantization level to zero for low-level signals.

34. A method of noise shaping as defined in claim 15, further comprising noise shaping of Layer 1 in an encoder of the codec and noise shaping of Layer 2 in a decoder of said codec.

35. A method of noise shaping as defined in claim 34, wherein noise shaping of Layer 1 in the encoder comprises subtracting Layer 2 from an output signal of a quantizer so as to produce a noise feedback based on Layer 1 only.

36. A method of noise shaping as defined in claim 34, wherein noise shaping of Layer 2 in the decoder comprises:
computing an output signal from Layer 1;
computing a filter transfer function based on the computed output signal from Layer 1;
computing an enhancement signal from Layer 2; and
filtering the enhancement signal from Layer 2 through the computer filter transfer function.

37. A method of noise shaping as defined in claim 34, further comprising G.711 codec as Layer 1 codec, and wherein shaping noise in Layer 1 comprises maintaining interoperability with legacy G.711 decoders.

38. A method for noise shaping in a multilayer encoder and decoder, including at least Layer 1 and Layer 2, the method comprising:
at the encoder:
producing an encoded sound signal in Layer 1, wherein producing an encoded sound signal comprises shaping noise in Layer 1;
producing an enhancement signal in Layer 2; and
at the decoder:
decoding the encoded sound signal from Layer 1 of the encoder to produce a synthesis sound signal;
decoding the enhancement signal from Layer 2;
computing a filter transfer function in relation to the synthesis sound signal;
filtering the decoded enhancement signal of Layer 2 through the computed filter transfer function to produce a filtered enhancement signal of Layer 2; and
adding the filtered enhancement signal of Layer 2 to the synthesis sound signal to produce an output signal including contributions from both Layer 1 and Layer 2.

39. A method of noise shaping as defined in claim 38, further comprising G.711 codec as Layer 1 codec, and wherein shaping noise in Layer 1 comprises maintaining interoperability with legacy G.711 decoders.

40. A method of noise shaping as defined in claim 38, wherein shaping noise in Layer 1 at the encoder comprises: pre-emphasizing a past decoded signal from Layer 1 so as to produce a pre-emphasized signal; computing a filter transfer function based on the pre-emphasized signal; and shaping the noise by filtering said noise through the computed filter transfer function to produce a shaped noise signal.

41. A method of noise shaping as defined in claim 40, further comprising producing a noise feedback representative of noise generated by processing through a Layer 1 and Layer 2 quantizer.

42. A method of noise shaping as defined in claim 41, wherein producing a noise feedback comprises removing the enhancement signal of Layer 2 from an output signal of the Layer 1 and Layer 2 quantizer.

43. A method of noise shaping as defined in claim 38, wherein computing the filter transfer function at the decoder comprises computing an expression
$$\frac{1}{A ( z / γ )} ,$$
where A(z) is a linear prediction filter computed in relation to the synthesis sound signal from Layer 1 and γ corresponding to a weighting factor.

44. A method of noise shaping as defined in claim 38, further comprising using a noise gate, at the decoder, for suppressing a synthesis sound signal which decreases below a given threshold.

45. A method of noise shaping as defined in claim 44, wherein suppressing the synthesis sound signal further comprises attenuating progressively an energy of the synthesis sound signal.

46. A method of noise shaping as defined in claim 45, further comprising calculating a target gain of the synthesis sound signal.

47. A method of noise shaping as defined in claim 46, wherein calculating the target gain of the synthesis sound signal comprises calculating an expression
$${g}_{t} = \frac{\sqrt{{E}_{t}}}{{2}^{7}} ,$$
with Eₜ being an energy of the synthesis sound signal over two frames.

48. A device for shaping noise during encoding of an input sound signal, the device comprising:
means for pre-emphasizing the input sound signal so as to produce a pre-emphasized signal;
means for computing a filter transfer function in relation to the pre-emphasized sound signal;
means for producing a noise feedback representative of noise generated by processing of the input sound signal through a given sound signal codec; and
means for shaping the noise by filtering the noise feedback through the computed filter transfer function to produce a shaped noise signal.

49. A device for shaping noise during encoding of an input sound signal, the device comprising:
a first filter for pre-emphasizing the input sound signal so as to produce a pre-emphasized signal;
a feedback loop for producing a noise feedback representative of noise generated by processing of the input sound signal through a given sound signal codec; and
a second filter having a transfer function determined in relation to the pre-emphasized signal, said second filter processing the noise feedback to produce a shaped noise signal.

50. A device for noise shaping as defined in claim 49, wherein the given sound signal codec comprises an ITU-T G.711 codec.

51. A device for noise shaping as defined in claim 49, wherein the first filter has a transfer function 1-μz⁻¹, where μ is an adaptive pre-emphasis factor and z representing a z-transform domain.

52. A device for noise shaping as defined in claim 51, further comprising a calculator of the adaptive pre-emphasis factor μ.

53. A device for noise shaping as defined in claim 49, wherein the feedback loop comprises an adder for computing a difference between an output signal of the given sound signal codec and the input sound signal.

54. A device for noise shaping as defined in claim 49, wherein the feedback loop further comprises a filter having a transfer function of A(z/γ)−1, where A(z) is a linear prediction filter and γ is a weighting factor.

55. A device for shaping noise during encoding of an input sound signal, the device comprising:
means for receiving a decoded signal from an output of a given codec supplied with the input sound signal;
means for pre-emphasizing the decoded signal so as to produce a pre-emphasized signal;
means for calculating a filter transfer function in relation to the pre-emphasized signal;
means for producing a noise feedback representative of noise generated by processing of the input sound signal through the given sound signal codec; and
means for shaping the noise by filtering the noise feedback through the computed filter transfer function.

56. A device for shaping noise during encoding of an input sound signal, the device comprising:
a receiver of a decoded signal from an output of a given sound signal codec;
a first filter for pre-emphasizing the decoded signal to produce a pre-emphasized signal;
a feedback loop for producing a noise feedback representative of noise generated by processing of the input sound signal through the given sound signal codec; and
a second filter having a transfer function determined in relation to the pre-emphasized signal, said second filter processing the noise feedback to produce a shaped noise signal.

57. A device for noise shaping as defined in claim 56, wherein the given sound signal codec is a G.711 codec.

58. A device for noise shaping as defined in claim 56, wherein the feedback loop comprises a filter having a transfer function A(z/γ)−1, where A(z) is a linear prediction filter and γ is a weighting factor.

59. A device for noise shaping as defined in claim 56, wherein the first pre-emphasizing filter has a transfer function 1-μz⁻¹, where μ is an adaptive pre-emphasis factor and z represents a z-transform domain.

60. A device for noise shaping as defined in claim 59, further comprising a calculator of the adaptive pre-emphasis factor μ.

61. A device for noise shaping as defined in claim 56, further comprising a protection element for protecting the feedback loop against instability of the shaping noise filter.

62. A device for noise shaping as defined in claim 61, wherein the protection element comprises a detector of signals having an energy concentrated in frequencies close to half of a sampling frequency.

63. A device for noise shaping as defined in claim 62, further comprising a calculator of a ratio between first and second autocorrelations of the decoded signal, the ratio being representative of a frequency distribution of the signal energy.

64. A device for noise shaping as defined in claim 56, further comprising a gain controller for reducing the feedback loop.

65. A device for noise shaping as defined in claim 56, further comprising a dead-zone quantizer for setting a quantization level to zero for low energy signals.

66. A device for shaping noise in a multilayer encoder and decoder, including at least Layer 1 and Layer 2, the device comprising:
at the encoder:
means for encoding a sound signal, wherein the means for encoding the sound signal comprises means for shaping noise in Layer 1; and
means for producing an enhancement signal from Layer 2; and
at the decoder:
means for decoding the encoded sound signal from Layer 1 so as to produce a synthesis signal from Layer 1;
means for decoding the enhancement signal from Layer 2;
means for calculating a filter transfer function in relation to the synthesis sound signal;
means for filtering the enhancement signal to produce a filtered enhancement signal of Layer 2; and
means for adding the filtered enhancement signal of Layer 2 to the synthesis sound signal so as to produce an output signal including contributions of both Layer 1 and Layer 2.

67. A device for shaping noise in a multilayer encoding device and decoding device, including at least Layer 1 and Layer 2, the device comprising:
at the encoding device:
a first encoder of a sound signal in Layer 1, wherein the first encoder comprises a filter for shaping noise in Layer 1; and
a second encoder of an enhancement signal in Layer 2; and
at the decoding device:
a decoder of the encoded sound signal to produce a synthesis sound signal;
a decoder of the enhancement signal in Layer 2;
a filter having a transfer function determined in relation to the synthesis sound signal from Layer 1, said filter processing the decoded enhancement signal to produce a filtered enhancement signal of Layer 2; and
an adder for adding the synthesis sound signal and the filtered enhancement signal to produce an output signal including contributions of both Layer 1 and Layer 2.

68. A device for noise shaping as defined in claim 67, further comprising a pre-emphasizing filter in the encoding device.

69. A device for noise shaping as defined in claim 67, further comprising, at the encoding device, a feedback loop representative of noise generated through processing a given sound codec of an input signal to the given sound codec.

70. A device for noise shaping as defined in claim 69, wherein the feedback loop in the encoding device comprises a filter with a transfer function of A(z/γ)−1, where A(z) is a linear prediction filter and γ is a weighting factor.

71. A device for noise shaping as defined in claim 70, wherein the feedback loop in the encoding device comprises an adder for adding the input signal to the given sound codec with the encoded sound signal.

72. A device for noise shaping as defined in claim 69, wherein the given sound codec comprises an ITU-T G.711 codec.

73. A device for noise shaping as defined in claim 67, further comprising a noise gate for suppressing the synthesis sound signal which has an energy level inferior to a given threshold.
